(19) United States
(12) Patent Application Publication
(10) Pub. No.: US 2025/0304867 A1
(43) Pub. Date: Oct. 2, 2025

(54) SYNTHESIS GAS PRODUCTION METHOD AND SYNTHESIS GAS PRODUCTION SYSTEM

(71) Applicant: HONDA MOTOR CO., LTD., Tokyo (JP)

(72) Inventors: Yusuke Oda, Wako-shi (JP); Kohtaro Hashimoto, Wako-shi (JP)

(21) Appl. No.: 19/069,465

(22) Filed: Mar. 4, 2025

(30) Foreign Application Priority Data
Mar. 28, 2024 (JP) 2024-053873

(51) Int. Cl. C10J 3/82

(52) U.S. Cl. CPC C10J 3/82; C10J 2300/0916; C10J 2300/0969; C10J 2300/1253

(57) ABSTRACT

A synthesis gas production method from a biomass raw material includes: a synthesis gas production step of producing a synthesis gas that includes hydrogen, carbon monoxide, and carbon dioxide from a biomass raw material, water, and carbon dioxide that are supplied, wherein the carbon dioxide supplied to the synthesis gas production step includes the carbon dioxide in the synthesis gas.

### CROSS-REFERENCE TO RELATED APPLICATION

Priority is claimed on Japanese Patent Application No. 2024-053873, filed on Mar. 28, 2024, the contents of which are incorporated herein by reference.

### BACKGROUND

### Field of the Invention

The present invention relates to a synthesis gas production method and a synthesis gas production system.

### Background

In the related art, efforts aiming at reduction of the impact on or moderation of climate change have been ongoing, and toward the realization of this purpose, research and development relating to reduction of carbon dioxide emissions has been conducted.

In recent years, as an alternative to fossil fuels, a synthetic fuel using hydrogen generated by electric power generated by renewable energy and carbon sources such as biomass or carbon dioxide discharged from factories as raw materials attracts attention.

A general procedure that produces a liquid fuel such as methanol or gasoline using biomass as a raw material is as follows. That is, a liquid fuel is produced from a biomass raw material through: a gasification step of gasifying a biomass raw material that has undergone a predetermined pretreatment together with water and oxygen in a gasification furnace and generating a synthesis gas that includes hydrogen and carbon monoxide; a cleaning step of cleaning the generated synthesis gas and removing tar; a H₂/CO ratio adjustment step of adjusting a H₂/CO ratio of the synthesis gas that has undergone the cleaning step to a target ratio corresponding to a liquid fuel to be produced; a desulfurization step of removing a sulfur component from the synthesis gas that has undergone the H₂/CO ratio adjustment step; and a fuel production step of producing a liquid fuel from the synthesis gas that has undergone the desulfurization step.

Here, the H₂/CO ratio of the synthesis gas generated through the gasification step does not reach the target ratio in many cases and is in a state in which hydrogen is insufficient. Therefore, by supplying water vapor in the gasification step, the H₂/CO ratio can also be close to 2.0 which is preferable in a Fischer-Tropsch synthesis reaction (hereinafter, also referred to as a FT synthesis reaction).

The carbon dioxide included in the synthesis gas is discharged as part of an offgas before being supplied to the FT synthesis reaction. However, when carbon dioxide is discharged to the environment, the load on the environment is large.

Japanese Unexamined Patent Application, First Publication No. 2021-147504 discloses an invention in which, in a fuel production system that produces a synthetic fuel from a biomass raw material as described above, hydrogen is generated by electric power generated by renewable energy, and by mixing the generated hydrogen with a synthesis gas generated by a gasification furnace, a H₂/CO ratio is adjusted to a target ratio without requiring a shift reactor. According to the fuel production system in Japanese Unexamined Patent Application, First Publication No. 2021-147504, by generating hydrogen by an electrolysis device using electric power generated by using renewable energy, it is possible to prevent generation of carbon dioxide in the entire fuel production system.

Japanese Unexamined Patent Application, First Publication No. 2012-214528 proposes a method of producing various carbon hydride oils from natural gas, the method including a step of recycling an offgas as a fuel for heating a gasification furnace. According to the production method of Japanese Unexamined Patent Application, First Publication No. 2012-214528, the offgas can be recycled.

### SUMMARY

However, in the fuel production system of Japanese Unexamined Patent Application, First Publication No. 2021-147504, since it is necessary to increase a supply amount of hydrogen, there is a problem that costs for generating hydrogen is increased.

Further, in the production method of Japanese Unexamined Patent Application, First Publication No. 2012-214528, although the offgas is combusted as a fuel for heating the gasification furnace, carbon dioxide is not combusted, and therefore, there is a problem that carbon dioxide cannot be effectively utilized.

Further, in the reduction of carbon dioxide emissions, only by recycling the offgas as a fuel, it is necessary to discharge the carbon dioxide generated by combustion, and there is a problem that the load on the environment is large.

The present application aims at providing a synthesis gas production method and a synthesis gas production system that are low-cost, can effectively utilize carbon dioxide, and can improve productivity while reducing the load on the environment. Further, the present application contributes to reduction of the impact on or moderation of climate change.

A first aspect of the present invention is a synthesis gas production method from a biomass raw material, the synthesis gas production method including: a synthesis gas production step of producing a synthesis gas that includes hydrogen, carbon monoxide, and carbon dioxide from a biomass raw material, water, and carbon dioxide that are supplied, wherein the carbon dioxide supplied to the synthesis gas production step includes the carbon dioxide in the synthesis gas.

In the synthesis gas production method according to the first aspect of the present invention, it is not necessary to increase a supply amount of hydrogen, the cost is low, and carbon dioxide can be effectively utilized as a raw material for producing a synthesis gas.

Further, since carbon dioxide is consumed as a raw material, it is possible to reduce carbon dioxide emissions, and it is possible to reduce the load on the environment.

Further, since renewable energy can be used as the necessary electric power, it is possible to improve productivity while reducing the load on the environment.

A second aspect is the synthesis gas production method according to the first aspect which may include: a carbon dioxide supply step of supplying the carbon dioxide in the synthesis gas to the synthesis gas production step.

In the synthesis gas production method according to the second aspect of the present invention, it is not necessary to increase a supply amount of hydrogen, the cost is low, and by supplying the carbon dioxide in the synthesis gas as a raw material for producing the synthesis gas, carbon dioxide can be effectively utilized.

A third aspect is the synthesis gas production method according to the first or second aspect which may include: a gas refinement step of separating the synthesis gas into an offgas that includes carbon dioxide and carbon hydride and a refinement synthesis gas that includes hydrogen and carbon monoxide.

The synthesis gas production method according to the third aspect of the present invention recycles the offgas that includes carbon dioxide and carbon hydride and can thereby further enhance an energy efficiency and further reduce the load on the environment. Further, by supplying the refinement synthesis gas that includes hydrogen and carbon monoxide to a FT synthesis reaction, it is possible to improve productivity of a liquid fuel.

A fourth aspect is the synthesis gas production method according to the third aspect which may include: a gas separation step of separating the offgas into a gasification assistance gas that includes carbon dioxide and a heat source gas that includes carbon hydride.

The synthesis gas production method according to the fourth aspect of the present invention supplies the gasification assistance gas that includes carbon dioxide to the synthesis gas production step and can thereby increase the supply amount of carbon dioxide. Further, the heat source gas that includes carbon hydride can be recycled as a fuel for heating the gasification furnace used in the synthesis gas production step, and it is possible to further enhance the energy efficiency and further reduce the load on the environment.

A fifth aspect is the synthesis gas production method according to the fourth aspect which may include: a heat source gas supply step of supplying the heat source gas as a heat source in the synthesis gas production step.

The synthesis gas production method according to the fifth aspect of the present invention recycles the heat source gas that includes carbon hydride as a fuel for heating a gasification furnace used in the synthesis gas production step, and thereby, it is possible to further enhance the energy efficiency and further reduce the load on the environment.

A sixth aspect is the synthesis gas production method according to any one of the first to fifth aspects which may include: a water vapor supply step of supplying water vapor as water in the synthesis gas production step such that a mass ratio represented by [mass of water vapor]/[mass of biomass] is 1.3 or more.

The synthesis gas production method according to the sixth aspect of the present invention adjusts the supply amount of the water vapor and can thereby perform an adjustment such that a hydrogen generation ratio is increased, and a mole ratio represented by [mole number of hydrogen]/[mole number of carbon monoxide] at the time of production of the synthesis gas is 2.0 or more. Further, by supplying carbon dioxide to this, it is possible to cause a reverse shift reaction (a reaction that generates carbon monoxide and water from hydrogen and carbon dioxide) to proceed, consume carbon dioxide and hydrogen, and generate carbon monoxide.

Thereby, since it is possible to produce a synthesis gas in which the mole ratio represented by [mole number of hydrogen]/[mole number of carbon monoxide] is close to 2.0 and which is optimal for the FT synthesis reaction, it is possible to further improve productivity.

A seventh aspect is the synthesis gas production method according to any one of the first to sixth aspects which may include: a carbon dioxide supply step of supplying carbon dioxide in the synthesis gas production step such that a mole ratio represented by [mole number of hydrogen]/[mole number of carbon monoxide] in the obtained synthesis gas is 1.95 to 2.05.

In the synthesis gas production method according to the seventh aspect of the present invention, by adjusting the supply amount of the carbon dioxide and performing an adjustment such that the mole ratio represented by [mole number of hydrogen]/[mole number of carbon monoxide] at the time of production of the synthesis gas is 1.95 to 2.05, it is possible to cause the reverse shift reaction to proceed, consume carbon dioxide, and generate carbon monoxide. Thereby, it is possible to produce a synthesis gas in which the mole ratio represented by [mole number of hydrogen]/[mole number of carbon monoxide] is close to 2.0 and which is optimal for the FT synthesis reaction, and it is possible to further improve productivity. Further, since carbon dioxide is consumed as a raw material, it is possible to reduce carbon dioxide emissions, and it is possible to reduce the load on the environment.

A synthesis gas production system according to an eighth aspect is a fuel production system for producing a fuel from a biomass raw material, the synthesis gas production system including: a gasification device that produces a synthesis gas which includes hydrogen, carbon monoxide, carbon dioxide, and carbon hydride from a biomass raw material, water, and carbon dioxide which are supplied; and a carbon dioxide supply device that supplies the carbon dioxide in the synthesis gas to the gasification device.

The synthesis gas production system according to the eighth aspect of the present invention does not need to increase a supply amount of hydrogen, can be operated at a low cost, can increase a supply amount of carbon dioxide by supplying carbon dioxide to the synthesis gas production step, and can further enhance an energy efficiency and further reduce the load on the environment.

A ninth aspect is the synthesis gas production system according to the eighth aspect which may include: a gas refinement device that separates the synthesis gas into an offgas which includes carbon dioxide and carbon hydride and a refinement synthesis gas which includes hydrogen and carbon monoxide.

The synthesis gas production system according to the ninth aspect of the present invention recycles the offgas which includes carbon dioxide and carbon hydride and can thereby further enhance an energy efficiency and further reduce the load on the environment. Further, by supplying the refinement synthesis gas which includes hydrogen and carbon monoxide to a FT synthesis reaction, it is possible to improve productivity of a liquid fuel.

A tenth aspect is the synthesis gas production system according to the ninth aspect which may include: a gas separation device that separates the offgas into a gasification assistance gas which includes carbon dioxide and a heat source gas which includes carbon hydride.

The synthesis gas production system according to the tenth aspect of the present invention supplies the gasification assistance gas which includes carbon dioxide to the synthesis gas production step and can thereby increase the supply amount of carbon dioxide. Further, the heat source gas which includes carbon hydride can be recycled as a fuel for heating the gasification furnace used in the synthesis gas production step, it is possible to further enhance the energy efficiency and further reduce the load on the environment.

An eleventh aspect is the synthesis gas production system according to the tenth aspect which may include: a heat source gas supply device that supplies the heat source gas as a heat source in a synthesis gas production step.

The synthesis gas production system according to the eleventh aspect of the present invention recycles the heat source gas which includes carbon hydride as a fuel for heating a gasification furnace used in the synthesis gas production step, and thereby, it is possible to further enhance the energy efficiency and further reduce the load on the environment.

A twelfth aspect is the synthesis gas production system according to any one of the eighth to eleventh aspects which may include: a water vapor supply device that supplies water vapor as water to the gasification device such that a mass ratio represented by [mass of water vapor]/[mass of biomass] is 1.3 or more.

The synthesis gas production system according to the twelfth aspect of the present invention adjusts the supply amount of the water vapor and can thereby perform an adjustment such that a hydrogen generation ratio is increased, and a mole ratio represented by [mole number of hydrogen]/[mole number of carbon monoxide] at the time of production of the synthesis gas is 2.0 or more. Further, by supplying carbon dioxide to this, it is possible to cause the reverse shift reaction to proceed, consume carbon dioxide and hydrogen, and generate carbon monoxide. Thereby, since it is possible to produce a synthesis gas in which the mole ratio represented by [mole number of hydrogen]/[mole number of carbon monoxide] is close to 2.0 and which is optimal for the FT synthesis reaction, it is possible to further improve productivity.

A thirteenth aspect is the synthesis gas production system according to any one of the eighth to twelfth aspects which may include: a carbon dioxide supply device that supplies carbon dioxide in the gasification device such that a mole ratio represented by [mole number of hydrogen]/[mole number of carbon monoxide] in the obtained synthesis gas is 1.95 to 2.05.

In the synthesis gas production system according to the thirteenth aspect of the present invention, by adjusting the supply amount of the carbon dioxide and performing an adjustment such that the mole ratio represented by [mole number of hydrogen]/[mole number of carbon monoxide] at the time of production of the synthesis gas is 1.95 to 2.05, it is possible to cause the reverse shift reaction to proceed, consume carbon dioxide, and generate carbon monoxide. Thereby, it is possible to produce a synthesis gas in which the mole ratio represented by [mole number of hydrogen]/[mole number of carbon monoxide] is close to 2.0 and which is optimal for the FT synthesis reaction, and it is possible to further improve productivity. Further, since carbon dioxide is consumed as a raw material, it is possible to reduce carbon dioxide emissions, and it is possible to reduce the load on the environment.

According to the aspect of the present invention, it is possible to provide a synthesis gas production method and a synthesis gas production system that are low-cost, can effectively utilize carbon dioxide, and can improve productivity while reducing the load on the environment. Further, it is possible to contribute to reduction of the impact on or moderation of climate change.

### BRIEF DESCRIPTION OF THE DRAWINGS

FIG. 1 is a flowchart showing the configuration of a synthesis gas production method according to an embodiment of the present invention.

FIG. 2 is a flowchart showing the configuration of a fuel production method according to the embodiment of the present invention.

FIG. 3 is a flowchart showing the configuration of a fuel production method according to another embodiment of the present invention.

FIG. 4 is a schematic view showing the configuration of a synthesis gas production system according to an embodiment of the present invention.

FIG. 5 is a schematic view showing the configuration of the fuel production system according to the embodiment of the present invention.

FIG. 6 is a schematic view showing the configuration of a fuel production system according to another embodiment of the present invention.

FIG. 7 is a flowchart showing a specific procedure of the fuel production method according to the embodiment of the present invention.

FIG. 8 is a graph representing a component amount in a synthesis gas in an example.

### DESCRIPTION OF EMBODIMENTS

Hereinafter, an outline of an embodiment of the present invention is described.

A synthesis gas generated by a reforming reaction of a biomass raw material flows into a bubble column reactor provided on a FT device from a bottom portion of the bubble column reactor. A slurry constituted of liquid carbon hydride which is a product material of a FT synthesis reaction and catalyst particles are filled in the bubble column reactor, and when the synthesis gas rises in the accommodated slurry, carbon hydride is generated by a FT synthesis reaction by carbon monoxide and hydrogen.

The carbon hydride in a liquid form among the synthesized carbon hydride is introduced into a separator together with the catalyst particles as a slurry and is separated into a component in a solid form such as catalyst particles and a component in a liquid form (Fischer-Tropsch oil) that includes liquid carbon hydride in the separator. The separated component in a solid form is caused to return to the bubble column reactor. After the component in a liquid form is supplied to a rectification column, is heated, and is fractionated by the difference of a boiling point, by performing hydrorefining or performing fractionating after hydrorefining is performed, a liquid fuel constituted of naphtha, SAF (Sustainable Aviation Fuel), diesel, and heavy components is obtained.

Typically, a synthesis gas that is optimal for a FT synthesis has a H₂/CO ratio close to 2.0. Therefore, in the present application, a shift reactor for adjusting the ratio to an optimum ratio is not required, and a synthesis gas having a H₂/CO ratio close to 2.0 is produced while effectively utilizing carbon dioxide.

Hereinafter, embodiments of a method of removing heavy carbon hydride in the present invention will be specifically described. However, the present invention is not limited to the following embodiments.

### <<Synthesis Gas Production Method>>

Hereinafter, a synthesis gas production method according to an embodiment of the present invention will be described with reference to the drawings.

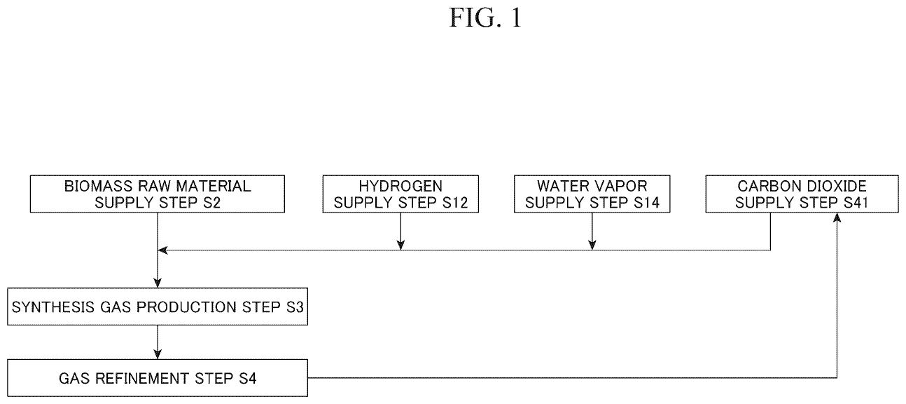

FIG. 1 is a flowchart showing a configuration of a synthesis gas production method according to the present embodiment.

In a biomass raw material supply step S2, a predetermined pretreatment is applied to a biomass raw material such as rice hulls, bagasse, and woods, and the biomass raw material that has undergone this pretreatment is supplied to a gasification furnace of a gasification device that performs a synthesis gas production step S3 via a raw material supply passage. Here, the pretreatment with respect to the biomass raw material includes, for example, a drying step of drying the raw material, a pulverization step of pulverizing the raw material, and the like.

A method of supplying the biomass raw material to the gasification furnace is not particularly limited, and a known supply method can be employed.

In a hydrogen supply step S12, hydrogen is supplied to the synthesis gas production step. Before the hydrogen is supplied to the synthesis gas production step, a refinement step for increasing the degree of purity of hydrogen or a pressure increase step for increasing the pressure of hydrogen may be performed.

A method of supplying hydrogen to the gasification furnace is not particularly limited, and a known supply method can be employed.

When a sufficient amount of hydrogen is generated in the synthesis gas production step S3 described later, the hydrogen supply step S12 may not be performed. For example, by increasing a supply amount of water vapor described later, a reaction represented by Formula (1-1) described later easily proceeds. Thereby, even when hydrogen is not supplied from the outside, it is possible to generate a sufficient amount of hydrogen for reacting with carbon dioxide and causing the reverse shift reaction to proceed, and it is possible to produce a synthesis gas that has a H₂/CO ratio close to 2.0 and is optimal for a FT reaction.

When hydrogen is supplied from the outside, with respect to the supply amount of hydrogen, a mass ratio represented by [mass of hydrogen]/[mass of biomass] is 0.01 to 0.05, can be preferably 0.01 to 0.04, and can be more preferably 0.01 to 0.03. When the mass ratio is within the range described above, since the adjustment is easily performed such that a ratio of hydrogen to carbon monoxide at the time of production of the synthesis gas is larger, and the reaction with carbon dioxide is easily performed by the reverse shift reaction, even when water vapor is not supplied, or even when the supply amount of water vapor is small, it is possible to reduce carbon dioxide emissions, and it is possible to produce the synthesis gas while reducing the load on the environment. Further, by recycling a carbon source and reducing the supply amount of biomass, it is possible to reduce generation of by-products such as tar.

In a water vapor supply step S14, in the synthesis gas production step, water vapor is supplied such that a mass ratio represented by [mass of water vapor]/[mass of biomass] is 1.3 or more. By supplying water vapor, biomass and water vapor react with each other, and a reaction represented by Formula (1-1) described later proceeds.

A method of supplying water vapor is not particularly limited, and a known method can be employed.

A method of adjusting water vapor such that the mass ratio represented by [mass of water vapor]/[mass of biomass] is 1.3 or more is not particularly limited, and the adjustment may be performed by using a water vapor supply amount adjustment device such as a valve that adjusts the amount of water vapor supplied into the gasification furnace on the basis of the mass of the biomass supplied into the gasification furnace.

The mass ratio represented by [mass of water vapor]/[mass of biomass] can be preferably 1.3 to 2.0, can be more preferably 1.4 to 1.8, and can be still more preferably 1.5 to 1.75. When the mass ratio is within the range described above, since the adjustment is easily performed such that a ratio of hydrogen included in the synthesis gas is larger, and the reaction with carbon dioxide is easily performed by the reverse shift reaction, even when water vapor is not supplied, or even when the supply amount of water vapor is small, it is possible to reduce carbon dioxide emissions, and it is possible to produce the synthesis gas while reducing the load on the environment. Further, by recycling a carbon source and reducing the supply amount of biomass, it is possible to reduce generation of by-products such as tar.

In a carbon dioxide supply step S41, carbon dioxide included in the synthesis gas is supplied to the synthesis gas production step. Before the carbon dioxide is supplied to the synthesis gas production step, a gas separation step for increasing the degree of purity of carbon dioxide or a pressure increase step for increasing the pressure of carbon dioxide may be performed.

A method of supplying carbon dioxide in the offgas to the gasification furnace is not particularly limited, and a known gas supply method can be employed.

In the synthesis gas production step S3, the biomass raw material, hydrogen, water, and carbon dioxide are caused to react, and the synthesis gas including hydrogen, carbon monoxide, carbon dioxide, and carbon hydride is produced.

A reaction condition in the synthesis gas production is not particularly limited, and a known reaction condition can be employed. In the synthesis gas production, a reaction may be performed under a nitrogen gas airflow.

When water and carbon dioxide are injected into the gasification furnace to which the biomass raw material is injected, a total of eight types of gasification reactions and reverse reactions of the gasification reactions, for example, as shown in Formulas (1-1) to (1-8) described below proceed in the gasification furnace, and the synthesis gas that includes hydrogen, carbon monoxide, carbon dioxide, and carbon hydride is generated. Here, the water molecule in the following formula may be derived from the biomass raw material or may be injected as water vapor.

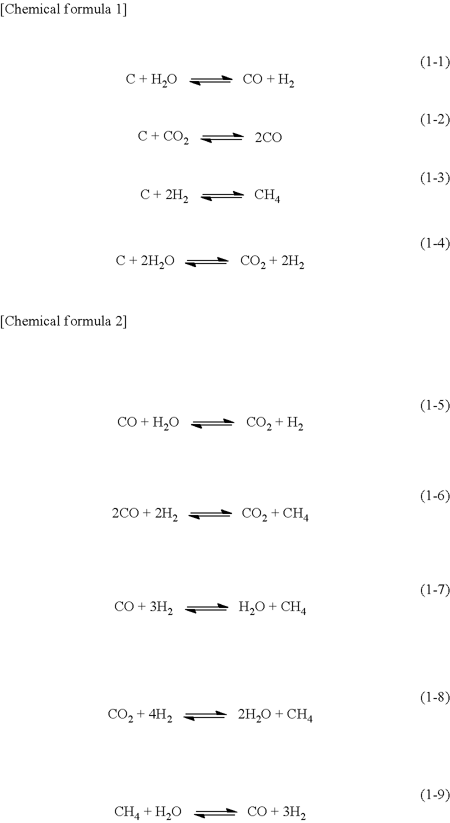

The mass ratio represented by [mass of carbon dioxide]/[mass of biomass] can be preferably 0.01 to 0.05, can be more preferably 0.01 to 0.04, and can be still more preferably 0.01 to 0.03. When the mass ratio is set within the range described above, since a reaction in which carbon dioxide reacts with hydrogen easily proceeds, and carbon dioxide is also easily consumed as a raw material of the synthesis gas, the load on the environment is easily reduced. Further, since excess hydrogen can be recovered and reused in the synthesis gas production step, the energy efficiency is more easily improved.

In the synthesis gas production step S3, as a first step, a biomass raw material, hydrogen, and water are caused to react, and a synthesis gas precursor having a H₂/CO ratio that is more than 2.0 is produced. Subsequently, as a second step, by supplying carbon dioxide from the outside and causing the reverse shift reaction to proceed, a synthesis gas in which the mole ratio represented by [mole number of hydrogen]/[mole number of carbon monoxide] is close to 2.0 and which is optimal for the FT synthesis reaction is produced. In the synthesis gas production step S3, these multistep reactions may be performed sequentially, or a one-pot reaction may be performed. The H₂/CO ratio of the synthesis gas precursor can be preferably more than 2.0, can be more preferably 2.2 or more, and may be 2.5 or more. When the H₂/CO ratio of the synthesis gas precursor is equal to or more than the lower limit value described above, since sufficient hydrogen for the reverse shift reaction exists, by supplying carbon dioxide to this, the reverse shift reaction easily proceeds. Thereby, a synthesis gas in which the mole ratio represented by [mole number of hydrogen]/[mole number of carbon monoxide] is close to 2.0 is easily produced. Further, since carbon dioxide is also easily consumed as a raw material of the synthesis gas, it becomes easy to reduce carbon dioxide emissions and reduce the load on the environment.

A gas refinement step S4 and a gas pressure increase step S5 may be provided after the synthesis gas production step S3 and before a Fischer-Tropsch synthesis step S6.

In the gas refinement step S4, after the H₂/CO ratio of the synthesis gas is adjusted to a predetermined target ratio by mixing hydrogen with the synthesis gas generated by the gasification reaction and the reverse reaction of the gasification reaction shown in Formulas (1-1) to (1-8) described above as needed, in order to supply the synthesis gas to the subsequent gas pressure increase step S5, unnecessary substances included in the synthesis gas is removed, and the synthesis gas is refined. For example, the H₂/CO ratio of the synthesis gas after refinement can be preferably 1.95 to 2.05, can be more preferably 1.98 to 2.02, and can be still more preferably 2.0. By setting the H₂/CO ratio of the refinement synthesis gas within the range described above, it is possible to obtain a synthesis gas in which the mole ratio represented by [mole number of hydrogen]/[mole number of carbon monoxide] is close to 2.0 and which is optimal for the FT synthesis reaction.

The synthesis gas is refined and is separated into a refinement synthesis gas having a H₂/CO ratio close to 2.0 and an offgas including carbon dioxide. The obtained offgas including carbon dioxide may be supplied as is to the gas production step, or may be further separated in a gas separation step S9 described later and is then supplied.

A method of refining the synthesis gas is not particularly limited, and a known refinement method can be employed.

In the gas separation step S9 (not shown), the offgas is separated into a gasification assistance gas that includes carbon dioxide and a heat source gas that includes carbon hydride.

A method of separating the gas is not particularly limited, and a known separation method can be employed. For example, by causing the offgas to pass through a column that separates the offgas in a size of a molecule, a gasification assistance gas that includes carbon dioxide is obtained as a first fraction, and then a heat source gas that includes carbon hydride can be obtained as a second fraction. Further, after the carbon hydride in the offgas is adsorbed by the column, and the gasification assistance gas is obtained as a first fraction, by placing the column under a reduced pressure condition or the like and recovering the carbon hydride adsorbed by the column, it is also possible to obtain a heat source gas that includes carbon hydride as a second fraction. Examples of a filler of the column include alumina, activated alumina, celite, a porous polymer, and the like. Further, it is also possible to distill and separate the offgas, or it is also possible to cool the offgas and condense and separate the heat source gas that includes carbon hydride.

In the gas separation step S9, the FT offgas generated in the Fischer-Tropsch synthesis step S6 may be separated into the gasification assistance gas that includes carbon dioxide and the heat source gas that includes carbon hydride similarly to the offgas described above.

In a heat source gas supply step (not shown), the heat source gas is supplied as a heat source in the synthesis gas production step.

A method of combusting the heat source gas is not particularly limited, and a known method can be employed.

Carbon dioxide generated by combusting the heat source gas may be used as carbon dioxide supplied in the carbon dioxide supply step S41.

As a synthesis gas production method according to another embodiment of the present invention, the carbon dioxide supplied in the carbon dioxide supply step S41 may be other than those derived from the synthesis gas, and may be, for example, air or may be carbon dioxide included in the FT offgas. The same steps as those described with respect to FIG. 1 can be employed as other steps.

### <<Liquid Fuel Production Method>>

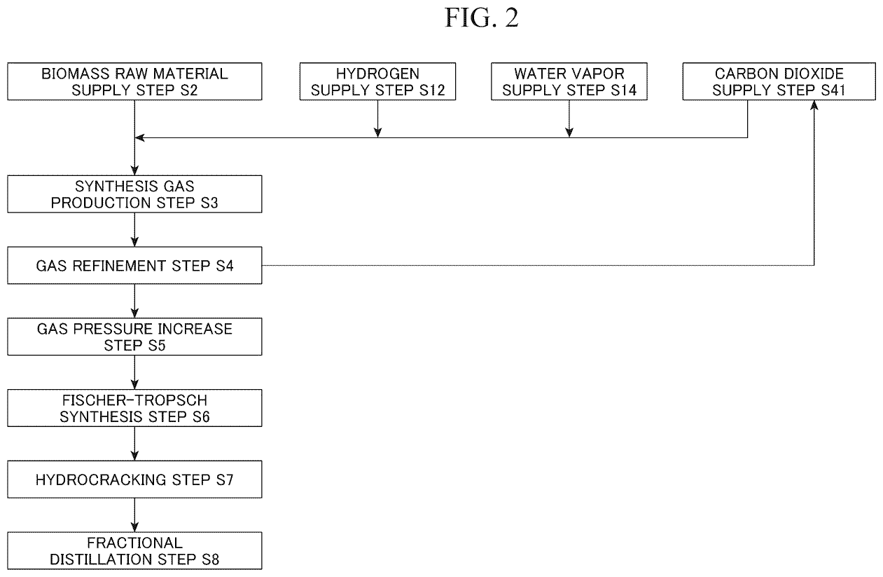

FIG. 2 is a flowchart showing the configuration of a liquid fuel production method according to the present embodiment.

The same steps as those described with respect to FIG. 1 can be employed for the steps from the biomass raw material supply step S2 to the heat source gas supply step.

In the gas pressure increase step S5, after the pressure of the synthesis gas that is supplied to the Fischer-Tropsch synthesis step is adjusted to a predetermined pressure (for example, 3 MPa) in accordance with a reaction condition of the Fischer-Tropsch reaction, the synthesis gas is supplied to the subsequent Fischer-Tropsch synthesis step.

A method of increasing the pressure of the synthesis gas is not particularly limited, and a known pressure adjustment method can be employed.

In the Fischer-Tropsch synthesis step S6, after performing a Fischer-Tropsch synthesis reaction of the synthesis gas, by separating the FT offgas including carbon dioxide, a Fischer-Tropsch oil is produced.

A reaction condition in the Fischer-Tropsch synthesis step S6 is not particularly limited, and a known reaction condition can be employed.

By the Fischer-Tropsch synthesis step S6, the Fischer-Tropsch oil that becomes a raw material of methanol, gasoline, and the like, and the FT offgas including carbon dioxide and carbon hydride are obtained from the synthesis gas.

Examples of the carbon hydride included in the FT offgas include carbon hydride having a carbon number of 1 to 5.

A hydrocracking step S7 of hydrocracking the Fischer-Tropsch oil may be provided after the Fischer-Tropsch synthesis step S6 and before a fractional distillation step S8.

In the hydrocracking step S7, heavy components (generally C₂₁ or more) included in the Fischer-Tropsch oil is hydrocracked by utilizing hydrogen, and the carbon number of the heavy components is reduced to C₂₀ or less. In this hydrocracking reaction, by utilizing a catalyst and heat, a C—C bond of carbon hydride having a large carbon number is cut, low-molecular-weight carbon hydride having a small carbon number is generated, and a liquid fuel constituted of naphtha, SAF, diesel, and heavy components is obtained.

A reaction condition in the hydrocracking is not particularly limited, and a known reaction condition can be employed.

In the case where the total mass of the carbon hydride generated after the FT synthesis reaction is 10 t or less, when the hydrocracking step S7 is performed after the Fischer-Tropsch synthesis step and before the fractional distillation step S8, since the amount of fractionation in the fractional distillation step S8 is reduced, the energy efficiency is excellent.

In the fractional distillation step S8, after hydrocracking the Fischer-Tropsch oil, the liquid fuel and the FT offgas are fractionated.

As a liquid fuel, specifically, fractionation into a naphtha fraction (the boiling point is less than about 200° C.), a SAF fraction (the boiling point is about 200 to 300° C.), a diesel fraction (the boiling point is about 200 to 350° C.), and a heavy component fraction (the boiling point is more than about 350° C.) is performed.

A gas obtained at the time of fractionation is recovered as the FT offgas. Carbon dioxide included in the offgas may be used as carbon dioxide that is supplied in the carbon dioxide supply step S41.

A method of fractionation is not particularly limited, and a known fractionation method can be employed.

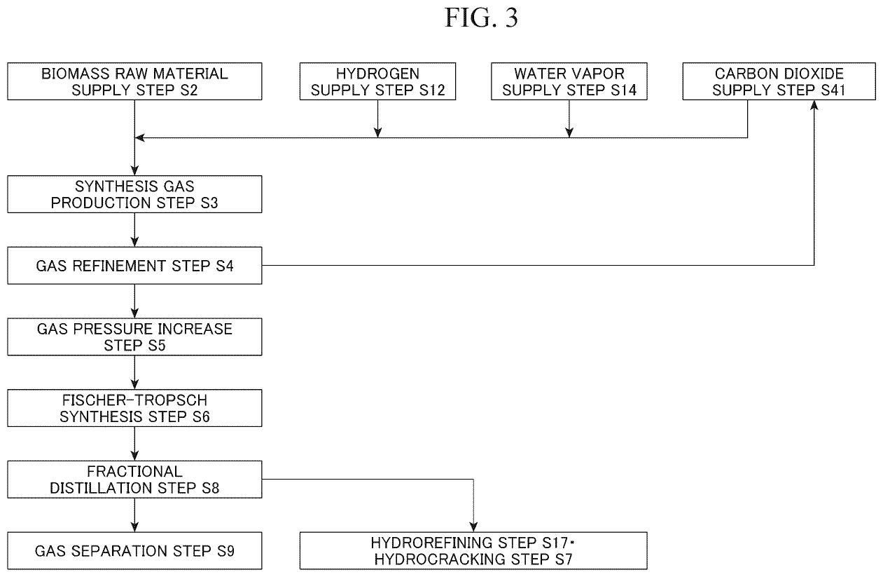

FIG. 3 is a flowchart showing the configuration of a fuel production method according to the present embodiment.

The same steps as those described with respect to FIG. 2 can be employed for the steps from the biomass raw material supply step S2 to the Fischer-Tropsch synthesis step S6.

In the fractional distillation step S8, after the Fischer-Tropsch synthesis step and before performing hydrorefining or hydrocracking of the Fischer-Tropsch oil, the Fischer-Tropsch oil and the FT offgas are fractionated.

A method of fractionation is not particularly limited, and a known fractionation method can be employed.

A hydrorefining step S17 that performs hydrorefining of the Fischer-Tropsch oil and a hydrocracking step S7 that performs hydrocracking may be provided after the Fischer-Tropsch synthesis step and after the fractional distillation step S8.

In the hydrorefining step S17, an unsaturated bond of unsaturated carbon hydride included in the liquid fuel after fractionation is hydrogenated, the unsaturated carbon hydride is converted into saturated carbon hydride, and then refinement is performed.

In the hydrocracking step S7, heavy components (generally C₂₁ or more) obtained after the Fischer-Tropsch oil is fractionated is hydrocracked by utilizing hydrogen.

In the case where the mass of the synthesis gas is more than 10 t, when the hydrorefining step S17 and the hydrocracking step S7 are performed after the Fischer-Tropsch synthesis step and after the fractional distillation step S8, since the amount of fractionation in the fractional distillation step S8 is reduced, the energy efficiency is excellent. In the hydrorefining step S17, unlike the hydrocracking step S7, since the C—C bond of carbon hydride is not cut, by-products having a carbon number that greatly differs and having a boiling point that greatly differs are hardly generated.

A reaction condition in the hydrocracking is not particularly limited, and a known reaction condition can be employed.

A reaction condition in the hydrorefining is not particularly limited, and a known reaction condition can be employed.

Carbon dioxide generated in the hydrocracking and the hydrorefining may be used as carbon dioxide that is supplied in the carbon dioxide supply step S41.

### <<Synthesis Gas Production System>>

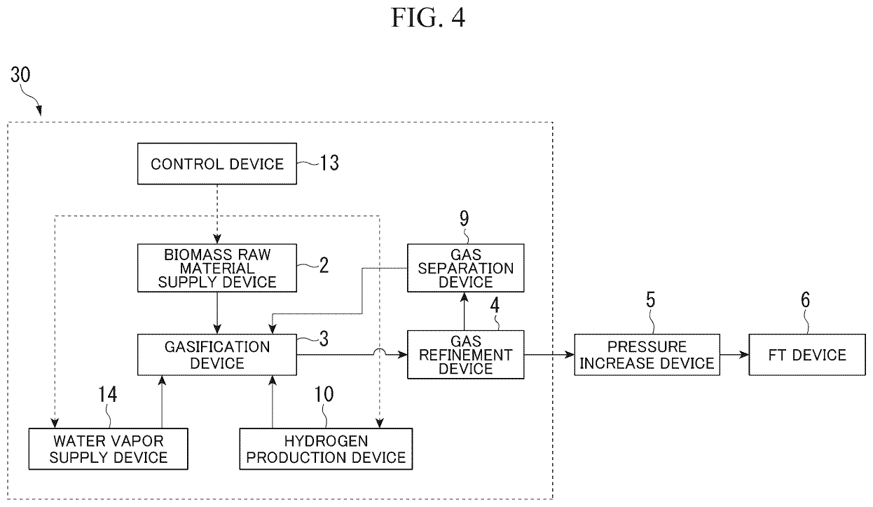

FIG. 4 is a schematic view showing the configuration of a synthesis gas production system 30 according to the present embodiment.

The synthesis gas production system 30 according to the present embodiment is a system for implementing the synthesis gas production method of FIG. 1. Therefore, descriptions of a fuel production system according to the present embodiment are not particularly limited as long as the contents described in the synthesis gas production method of FIG. 1 can be implemented, and an existing device can be used.

In a gasification device 3, a biomass raw material, hydrogen, water, and carbon dioxide are caused to react, and a synthesis gas including hydrogen, carbon monoxide, carbon dioxide, and carbon hydride is produced.

A hydrogen production device (hydrogen supply device) 10 supplies hydrogen to the gasification device 3.

In a gas separation device 9, an offgas is separated into a gasification assistance gas that includes carbon dioxide and a heat source gas that includes carbon hydride.

In a carbon dioxide supply device (not shown), the gasification assistance gas is supplied as a raw material to the gasification device 3. The carbon dioxide supply device is not particularly limited and may be a pipe that causes the gas separation device 9 and the gasification device 3 to communicate with each other, or may be constituted of a carbon dioxide tank that stores carbon dioxide between the gas separation device 9 and the gasification device 3 and a pipe that causes the carbon dioxide tank and the gasification device 3 to communicate with each other.

In a heat source gas supply device (not shown), the heat source gas is supplied as a heat source for heating a gasification furnace used for synthesis gas production in the gasification device 3.

In a water vapor supply device 14, water vapor is supplied to the gasification device 3.

### <<Fuel Production System>>

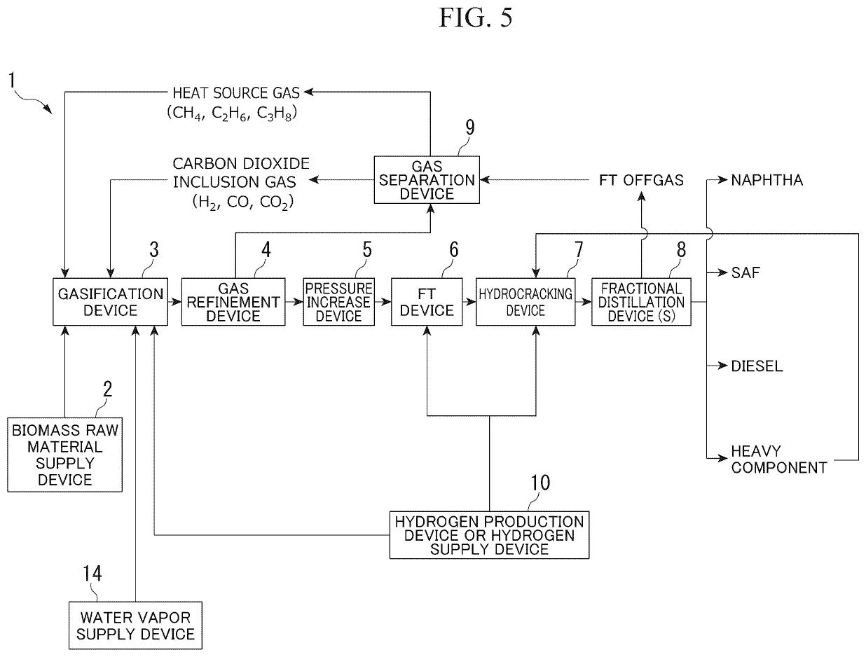

FIG. 5 is a schematic view showing a configuration of a fuel production system 1 according to the present embodiment.

The fuel production system 1 according to the present embodiment is a system for implementing the fuel production method of FIG. 2. Therefore, descriptions of the fuel production system 1 according to the present embodiment are not particularly limited as long as the contents described in the fuel production method of FIG. 2 can be implemented, and an existing device can be used.

Further, the same devices as those described with respect to FIG. 4 can be employed for the devices from the biomass raw material supply device 2 to the gas refinement device 4.

In a Fischer-Tropsch device (FT device) 6, after performing a Fischer-Tropsch synthesis reaction of the synthesis gas, by separating the FT offgas including carbon dioxide, a Fischer-Tropsch oil is produced.

In a hydrocracking device 7, heavy components (generally C₂₁ or more) included in the Fischer-Tropsch oil is hydrocracked by utilizing hydrogen, and a liquid fuel constituted of naphtha, SAF, diesel, and heavy components is obtained.

In the case where the total mass of the carbon hydride generated after the FT synthesis reaction is 10 t or less, when the hydrocracking device 7 is provided on a downstream side of the Fischer-Tropsch device 6 and an upstream side of a fractional distillation device(S) 8, since the amount of fractionation in the fractional distillation device(S) 8 is reduced, the energy efficiency is excellent.

In the fractional distillation device(S) 8, after hydrocracking the Fischer-Tropsch oil, the liquid fuel and the FT offgas are fractionated.

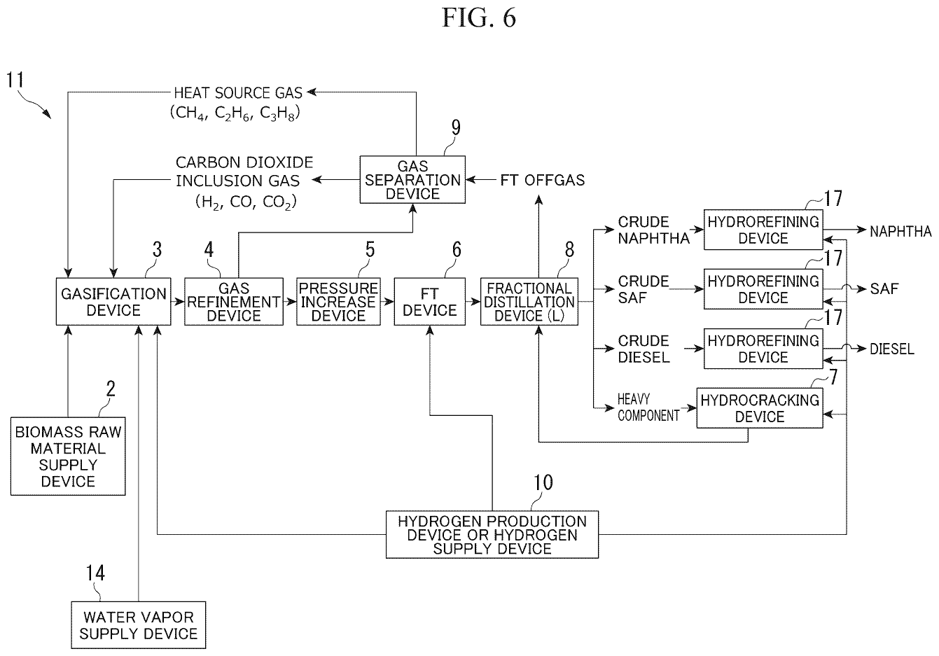

FIG. 6 is a schematic view showing a configuration of a fuel production system 11 according to the present embodiment.

The fuel production system 11 according to the present embodiment is a system for implementing the fuel production method of FIG. 3. Therefore, descriptions of the fuel production system 11 according to the present embodiment are not particularly limited as long as the contents described in the fuel production method of FIG. 3 can be implemented, and an existing device can be used.

Further, the same devices as those described with respect to FIG. 5 can be employed for the devices from the biomass raw material supply device 2 to the Fischer-Tropsch device 6.

In a fractional distillation device (L) 8, the liquid fuel and the FT offgas are fractionated at a downstream side of the Fischer-Tropsch device and an upstream side of a hydrocracking device that hydrocracks the Fischer-Tropsch oil.

In a hydrorefining device 17, an unsaturated bond of unsaturated carbon hydride included in the liquid fuel after fractionation is hydrogenated, the unsaturated carbon hydride is converted into saturated carbon hydride, and then refinement is performed.

In the hydrocracking device 7, heavy components (generally C₂₁ or more) obtained after the Fischer-Tropsch oil is fractionated is hydrocracked by utilizing hydrogen.

In the case where the mass of the synthesis gas is more than 10 t, when the hydrorefining device 17 and the hydrocracking device 7 are provided on a downstream side of the Fischer-Tropsch device 6 and a downstream side of the fractional distillation device (L) 8, since the amount of fractionation in the fractional distillation device (L) 8 is reduced, the energy efficiency is excellent.

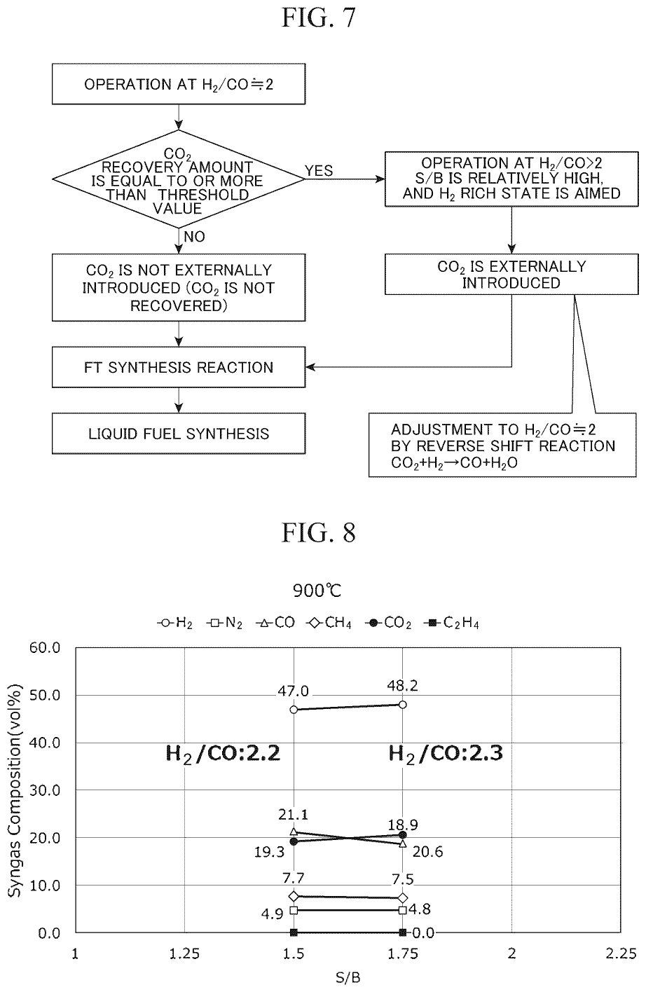

FIG. 7 is a flowchart showing a specific procedure of the fuel production method according to the embodiment of the present invention.

First, an initial synthesis gas is produced, and it is determined whether or not a CO₂ recovery amount derived from an offgas is equal to or more than a threshold value. When the determination is YES, an operation is performed so as to increase a supply amount of water vapor in the subsequent gasification reaction and increase a generation amount of hydrogen. By supplying the recovered CO₂ to this, causing the reverse shift reaction to proceed, consuming hydrogen and carbon dioxide, and generating carbon monoxide, a synthesis gas in which the H₂/CO ratio is close to 2.0 and which is optimal for the FT synthesis reaction is produced. The obtained synthesis gas is supplied to the FT synthesis reaction, and the liquid fuel is finally synthesized. When the determination is NO, the obtained synthesis gas is supplied to the FT synthesis reaction as is without supplying CO₂ from the outside.

### EXAMPLE

Hereinafter, the present invention is described more specifically using an example; however, the present invention is not limited to the example described below.

### Example 1

The supply amount of water vapor was adjusted such that the mole ratio represented by [mole number of hydrogen]/[mole number of carbon monoxide] was 2.0 or more and such that the mass ratio (hereinafter, also referred to as a S/B ratio) represented by [mass of water vapor]/[mass of biomass raw material] was a value shown in Tables 1 and 2. The amount of components in a synthesis gas precursor in respective elapsed times and S/B ratios were measured. The results are shown in Tables 1 and 2. The component amount in the synthesis gas is shown in FIG. 8.

TABLE 1

| | | | | | | | | S/B |
|---|---|---|---|---|---|---|---|---|
| EXAMPLE | | H₂ | N₂ | CO | CH₄ | CO₂ | C₂H₄ | RATIO |
| 1 | 15:34 | 46.924 | 5.3393 | 20.913 | 7.6124 | 19.212 | 0 | 1.5 |
| | 15:54 | 47.026 | 4.8181 | 21.043 | 7.7661 | 19.347 | 0 | |
| | 16:14 | 47.059 | 4.5633 | 21.260 | 7.8625 | 19.255 | 0 | |
| | Average | 47.00 | 4.91 | 21.07 | 7.75 | 19.27 | 0.00 | |
| 2 | Average | 46.43 | 4.65 | 21.78 | 8.10 | 19.03 | 0.00 | 1.5 |

TABLE 2

| | | | | | | | | S/B |
|---|---|---|---|---|---|---|---|---|
| EXAMPLE | | H₂ | N₂ | CO | CH₄ | CO₂ | C₂H₄ | RATIO |
| 3 | 17:14 | 47.954 | 5.4201 | 18.780 | 7.4022 | 20.444 | 0 | 1.75 |
| | 17:34 | 48.232 | 4.6089 | 18.977 | 7.5216 | 20.638 | 0.022 | |
| | 17:54 | 48.330 | 4.414 | 18.874 | 7.5318 | 20.851 | 0 | |
| | Average | 48.17 | 4.81 | 18.88 | 7.49 | 20.64 | 0.01 | |

As shown in FIG. 8, it has been found that by adjusting the supply amount of water vapor, a synthesis gas precursor which has a large hydrogen content and in which the mole ratio represented by [mole number of hydrogen]/[mole number of carbon monoxide] is more than 2.0 is obtained. Since a reverse shift reaction occurs by supplying carbon dioxide to the obtained synthesis gas precursor, it is estimated that a synthesis gas in which the mole ratio represented by [mole number of hydrogen]/[mole number of carbon monoxide] is 2.0 or more can be adjusted such that the mole ratio is a value close to 2.0.

The present invention is not limited to the embodiments described above, and modifications and improvements within a scope in which the object of the present invention can be achieved are included in the present invention.

What is claimed is:

1. A synthesis gas production method from a biomass raw material, the synthesis gas production method comprising:
a synthesis gas production step of producing a synthesis gas that includes hydrogen, carbon monoxide, and carbon dioxide from a biomass raw material, water, and carbon dioxide that are supplied,
wherein the carbon dioxide supplied to the synthesis gas production step includes the carbon dioxide in the synthesis gas.

2. The synthesis gas production method according to claim 1, comprising:
a carbon dioxide supply step of supplying the carbon dioxide in the synthesis gas to the synthesis gas production step.

3. The synthesis gas production method according to claim 1, comprising:
a gas refinement step of separating the synthesis gas into an offgas that includes carbon dioxide and carbon hydride and a refinement synthesis gas that includes hydrogen and carbon monoxide.

4. The synthesis gas production method according to claim 3, comprising:
a gas separation step of separating the offgas into a gasification assistance gas that includes carbon dioxide and a heat source gas that includes carbon hydride.

5. The synthesis gas production method according to claim 4, comprising:
a heat source gas supply step of supplying the heat source gas as a heat source in the synthesis gas production step.

6. The synthesis gas production method according to claim 1, comprising:
a water vapor supply step of supplying water vapor as water in the synthesis gas production step such that a mass ratio represented by [mass of water vapor]/[mass of biomass] is 1.3 or more.

7. The synthesis gas production method according to claim 1, comprising:
a carbon dioxide supply step of supplying carbon dioxide in the synthesis gas production step such that a mole ratio represented by [mole number of hydrogen]/[mole number of carbon monoxide] in the obtained synthesis gas is 1.95 to 2.05.

8. A synthesis gas production system for producing a fuel from a biomass raw material, the synthesis gas production system comprising:
a gasification device that produces a synthesis gas which includes hydrogen, carbon monoxide, carbon dioxide, and carbon hydride from a biomass raw material, water, and carbon dioxide which are supplied; and
a carbon dioxide supply device that supplies the carbon dioxide in the synthesis gas to the gasification device.

9. The synthesis gas production system according to claim 8, comprising:
a gas refinement device that separates the synthesis gas into an offgas which includes carbon dioxide and carbon hydride and a refinement synthesis gas which includes hydrogen and carbon monoxide.

10. The synthesis gas production system according to claim 9, comprising:
a gas separation device that separates the offgas into a gasification assistance gas which includes carbon dioxide and a heat source gas which includes carbon hydride.

11. The synthesis gas production system according to claim 10, comprising:
a heat source gas supply device that supplies the heat source gas as a heat source in a synthesis gas production step.

12. The synthesis gas production system according to claim 8, comprising:
a water vapor supply device that supplies water vapor as water to the gasification device such that a mass ratio represented by [mass of water vapor]/[mass of biomass] is 1.3 or more.

13. The synthesis gas production system according to claim 8, comprising:
a carbon dioxide supply device that supplies carbon dioxide in the gasification device such that a mole ratio represented by [mole number of hydrogen]/[mole number of carbon monoxide] in the obtained synthesis gas is 1.95 to 2.05.
